(19) United States
(12) Patent Application Publication
(10) Pub. No.: US 2021/0158309 A1
(43) Pub. Date: May 27, 2021

(54) SYSTEMS AND METHODS FOR PROCESSING ELECTRONIC PAYMENT REQUESTS

(71) Applicant: Wells Fargo Bank, N.A., San Francisco, CA (US)

(72) Inventors: James McGinlay, Staten Island, NY (US); Robert Ortiz, Clarks Green, PA (US); Barbara H. Stockler, Berwyn, PA (US); Joanne Strobel-Cort, Summit, NJ (US); Leonard J. Valentino, Stamford, CT (US)

(21) Appl. No.: 15/816,007

(22) Filed: Nov. 17, 2017

Related U.S. Application Data
(60) Provisional application No. 62/440,285, filed on Dec. 29, 2016.

(51) Int. Cl. G06Q 20/04; G06Q 20/10; G06Q 20/40; G06Q 20/32; G06Q 30/06; G06K 9/58; G06K 9/00; G06N 3/02

(52) U.S. Cl. CPC G06Q 20/042; G06Q 20/102; G06Q 20/401; G06Q 20/3278; G06N 3/126; G06K 9/58; G06K 9/00442; G06N 3/02; G06Q 30/06

(57) ABSTRACT

A computer implemented method performed by a payment processing system includes receiving a payment request from a payor and extracting payment data from the payment request. The payment data includes payee identification data and payment amount data. The method includes determining additional payment information required to complete the payment and dynamically generating a payment information request form. The payment information request form includes requests for specific data from the payor based on the determined additional payment information. The method includes validating the payment request based on the received payment request and the determined additional payment information to determine if the payment request is valid. The method includes generating a payment request data packet, the generation of the payment request data packet based on the payment request being determined to be a valid payment request. The payment request data packet includes the information required by the payee to process the payment.

### CROSS-REFERENCE TO RELATED APPLICATION

This application claims priority to U.S. Provisional Patent Application No. 62/440,285 entitled “SYSTEMS AND METHODS FOR PROCESSING ELECTRONIC PAYMENT REQUESTS,” filed Dec. 29, 2016, and incorporated herein by reference in its entirety.

### BACKGROUND

With the rise of electronic banking, many consumers are performing their transactions electronically, whether via an electronic banking machine, such as an ATM, or via the internet. However, providing paper documents to a banking provider, such as a financial institution, is often required, particularly when the transaction involves payment requests. While simple bill payments are performed easily enough using common tools, more sophisticated clients, or to some degree unsophisticated clients, may utilize physical payment requests. These payments requests may be checks, purchase orders, invoices, or other requests for payment. Often these payment requests must be manually input and converted into one or more standard financial industry data packets. However, this can often be time consuming for the provider. Further, if a mistake is found in the payment requests that can prohibit the payment requests from being processed, it may not be determined until after the consumer has left or is no longer immediately available. This can result in time delays in processing the payment requests, which may result in fee or fines to the consumer. Further, where the payments are performed between parties in different countries, additional information may be required that may not be known prior to the payment request being entered by the provider.

### SUMMARY

According to one example embodiment, a computer implemented method includes receiving, by a financial institution computing system, a payment request from a payor. The method further includes extracting, by the computing system, payment data from the payment request, the payment data including payee identification data and payment amount data. The method also includes determining, by the computing system, additional payment information required to complete the payment and dynamically generating a payment information request form. The payment information request form includes one or more requests for specific data from the payor based on the determined additional payment information. The method also includes validating the payment request based on the received payment request and the determined additional payment information to determine if the payment request is valid. The method includes generating, by the computing system, a payment request data packet. The payment request data packet include the information required by the payee to process the payment.

According to another example embodiment a system for processing electronic payments includes a payment processing system. The payment processing system is configured to receive, at a network interface circuit, a payment request from a payor and extract payment data from the payment request using an optical character recognition circuit. The payment data includes payee identification data and payment amount data. The payment processing system is further configured to determine additional payment information required to completed the payment and generate a payment information request form. The payment information request form includes one or more requests for specific data from the payor based on the determined additional payment information. The payment processing system is further configured to validate the payment request based on the received payment request and the determined additional payment information to determine if the payment request is valid. The payment processing system is also configured to generate a payment request data packet. The payment request data packet includes the information required by the payee to complete the payment. The payment processing system is further configured to transmit the payment requested data packet, via the network interface circuit, to a financial institution associated with the payee.

According to another example embodiment a system for processing electronic payments includes a payment processing system. The payment processing system is configured to receive a payment request from a payor at a network interface circuit, and extract payment data from the payment request using an optical character recognition circuit. The payment data includes payee identification data and payment amount data. The payment processing system is further configured to determine additional payment information required to completed the payment and generate a payment information request form. The payment information request form includes one or more requests for specific data from the payor based on the determined additional payment information. The payment processing system is further configured to validate the payment request based on the received payment request and the determined additional payment information to determine if the payment request is valid. The payment processing system is further configured to generate an additional payment information request form based on the payment request being determined to be an invalid payment request. The payment processing system is further configured to receive a completed additional payment information form via the network interface circuit, and to revalidate the payment request based on the received payment request and the received completed additional payment information request form. The payment processing system is also configured to generate a payment request data packet. The generation of the payment request data packet is based on the payment request being determined to be a valid payment request. The payment request data packet includes the information required by the payee to complete the payment. The payment processing system further configured to transmit the payment request data packet, via the network interface circuit, to a financial institution associated with the payee.

These and other features, together with the organization and manner of operation thereof, will become apparent from the following detailed description when taken in conjunction with the accompanying drawings.

### BRIEF DESCRIPTION OF THE FIGURES

FIG. 1 is a block diagram of an electronic payment processing system, according to an embodiment.

FIG. 2 is a block diagram of an alternative payment processing system, according to an embodiment.

FIG. 3 is block diagram illustrating an example payment request, according to various embodiments.

FIG. 4 is a flow diagram illustrating an electronic payment request process, according to various embodiments.

FIG. 5 is a flow diagram illustrating an example implementation of the method shown in FIG. 4.

FIG. 6 is a flow diagram illustrating an alternative example implementation of the method shown in FIG. 4.

### DETAILED DESCRIPTION

With the rise in online banking, and other online financial services, consumers have become more reliant on processing payments using one or more electronic services. However, some payments are still requested using paper forms. The use of paper forms can, and often does, lead to delays in processing payments due to the time it takes to input the data from the physical forms into one or more electronic payment processing systems. Additionally, factors such as the type of payee, the type of payment being made, the location of the payee, etc., can all require additional information to be provided. For example, payments made to payees in various countries can require additional information that may not be on a standard payment request form, requiring the payor to be contacted to obtain the additional information. Furthermore, where the data from a payment form must be entered into a payment system manually, the requirements for additional information may not be known for some time, resulting in additional time and costs to process the payment. Even when payment requests are submitted via standard electronic forms, additional information may be required which can result in a transaction failing or being delayed due to insufficient information being presented to an electronic payment processing system. Accordingly, it would be desirable to have systems and methods for automatically extracting payment information from both paper and electronic payments requests, and processing the payment request to determine if additional information is required to complete the payment. Further, feedback could be provided to the payor in real-time, or near real-time, in which the payor could promptly provide the required information directly to the electronic payment processing system to complete the payment.

Referring generally to the figures, systems and methods for providing automatic evaluation of payment requests and dynamic generation of additional data requests are shown in various embodiments. According to various embodiments, a payment processing system can receive one or more payment requests for processing. The payment processing system may utilize an optical character recognition (OCR) circuit to extract information related to the payment from one or more paper forms. Further, the payment processing system may utilize artificial intelligence to evaluate the extracted data and determine what additional data may be required to process the payment request. The payment processing system may further include a form generation circuit for generating one or more information request forms which can be provided to the payor, thereby allowing the payor to provide additional payment information that may be required to process the payment.

According to various embodiments, as described in further detail below, providing systems and methods for extracting payment request data, evaluating and processing the extracted payment request data, and dynamically generating information request forms to the payor to provide required missing information provides an improved interface for the payor. The experience is improved by easing the way in which payment requests are processed, and providing nearly real-time feedback to the payor when issues arise. By automatically extracting payment information from a variety of input methods and dynamically generating feedback forms for individual payment requests, additional value-add functionality can be achieved, as the payor can immediately cure potential defects within the payment request to reduce delays and costs associated with the payment. This aids in reducing the number of failed payments by evaluating payment requests in real time, thereby reducing time to complete the transaction, as well as costs associated with a failed transaction. Accordingly, the embodiments described herein solve the technical and internet-centric problem of providing a payment processing system to allow for easier, more accurate, and more reliable (i.e., completed at a higher percentage of the time the first time the transaction is submitted) payment requests, and specifically international payment requests.

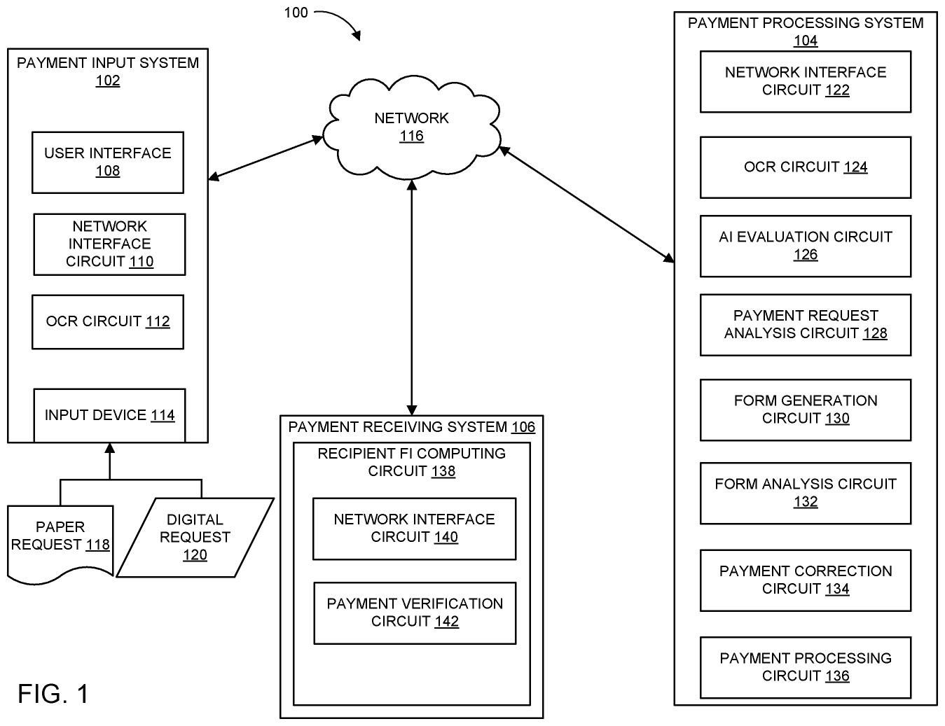

FIG. 1 is a block diagram of an electronic payment processing system 100. As shown in FIG. 1, the electronic payment processing system 100 includes a payment input system 102, a payment processing system 104, and a payment receiving system 106. The payment input system 102, the payment processing system 104, and the payment receiving system 106 may each comprise a computer system (e.g., one or more servers, each with one or more processing circuits), each including a processor and a memory. The processor may be implemented as application specific integrated circuit (ASICs), one or more field programmable gate arrays (PFGAs), a group of processing components, or other suitable electronic processing components. The memory may be one or more devices (e.g., RAM, ROM, Flash memory, hard disk storage, etc.) for storing data and/or computer code for completing and/or facilitating the various processes described herein. The memory may be or include non-transient volatile memory, non-volatile memory, and non-transitory computer storage media. The memory may include database components, object code components, script components, or any other type of information structure for supporting the various activities and information structures described herein. The memory may be communicable connected to the processor and include computer code or instructions for executing one or more processes described herein. In some arrangements, the payment processing system 104 and the payment input system 102 are part of the same banking provider, such as a financial institution (e.g., a payment originating financial institution). In such arrangements, the payment input system 102 and the payment processing system 104 may be supported by the same computing system.

The payment input system 102, the payment processing system 104, and/or the payment receiving system 106 may include a server-based computing system, for example, comprising one or more networked computer servers that are programmed to perform the operations described herein. The payment input system 102, the payment processing system 104, and/or the payment receiving system 106 may be implemented as a distributed computer system, where each function is spread over multiple computer systems.

The payment input system 102 is any device that allows a payor to input data related to performing one or more transactions, such as payment requests. As described herein, payment request are requests to transfer monetary funds from an account of the payor, to one or more payee accounts. In some embodiments, the payor and the payee are located in different countries, which can require that additional information be provided to complete the payment request. However, in some instances, the payment requests may be generated to request a payment from the payee to the payor. Accordingly, the terms “payor” and “payee” are exemplary only and should not be construed as limiting within this disclosure. The payment input system 102 may be a system or device associated with a financial institution (FI). For example, the payment input system 102 may be an automatic teller machine (ATM) or an automatic banking machine (ABM), such as a payment kiosk. In other examples, the payment input system 102 may be one or more computer systems within an FI used to enter payment requests presented by a customer of the FI. In still further embodiments, the payment input system 102 may be a home computing system, which allows for a payor to enter one or more payment requests at a time, which can then be presented to a payment processing system 104 to be processed.

As shown in FIG. 1, the payment input system 102 includes a user interface 108, a network interface circuit 110, an optical character recognition (OCR) circuit 112, and an input device 114. The user interface 108 may be any interface providing inputs and outputs within the payment input system 102. For example, the user interface 108 may be a touchscreen display associated with the payment input system 102. In other examples, the user interface 108 may be a combination of a display and a separate input device, such as a keyboard. In still further examples, the user interface 108 may be an audio interface, such as a virtual assistant such as Apple's® Siri,® or other virtual assistants. The network interface circuit 110 facilitates data communications to and from a network 116. The network interface circuit 110 may be configured to communicate wirelessly to the network 116, such as via Wi-Fi, Bluetooth, NFC, ZigBee, IR, RF, cellular (3G, 4G, LTE, CDMA), etc. In other arrangements, the network interface circuit 110 may communicate with the network 116 via a wired connection, such as via Ethernet, a LAN, a WAN, Firewire, USB, or other applicable wired interface. In some arrangements, data passing through the network interface circuit 110 is encrypted.

In some arrangements, the network 116 may be an internet based network. For example, the components of the electronic payment processing system 100 may all be in communication with a cloud-based network. In some arrangements, the network connections between the components are wired network connections, such as a TCP/IP network. In other arrangements, the network connections may be wireless network, such as Wi-Fi, Wi-Max, cellular (3G, 4G, LTE, CDMA), LoRA, ZigBee, Near Field Communication (NFC), Bluetooth, or any other applicable wireless network protocols.

The input device 114 may be used to input the payment request into the payment input system 102. In one example, the input device 114 may be a digital imaging device configured to image physical documents, such as a paper payment request 118. Example digital imaging devices may include digital scanners, digital imaging sensors (charged coupled devices (CCD), complementary metal-oxide-semiconductor (CMOS), or other digital imaging sensor). Some input devices 114 may allow a payor to insert one or more paper payment requests 118 into the input device 114, where they are imaged and returned to the payor. The paper payment requests 118 may include various form types. In one example, the paper payment requests 118 are forms that are provided and/or approved by an FI (e.g. forms provided by the FI to the payor). Other examples of paper payment requests may include forms unique to the payor or the payee but which contain similar information to the FI-provided payment request forms. In other arrangements, the paper payment requests 118 may be presented to an employee associated with an FI, who can image the paper payment request 118 using an input device 114. In other arrangements, the payor may position the paper payment requests 118 in a predefined location relative to the input device 114 of the payment input system 102, which can then image the paper payment requests 118 provided by the user. The input device 114 may further be configured to accept digital payment requests 120. For example, the payor may be able to manually enter the payment request data into the input device 114, such as by using the user interface 108. In other arrangements, the payor may image the payment requests using a personal imaging device, such as a scanner or a digital camera. The payor can then provide these digital payment requests 120 to the input device 114 for processing. The OCR circuit 112 is configured to convert physical text, such as on a scanned document, or in a computer file containing non-machine readable text, such as a portable document format (PDF) file, or image file (JPEG, RAW, etc.). The OCR circuit 112 is configured to convert the physical text into computer-recognizable text, which can be used to extract data from the physical text, such as paper payment request 118 or digital payment request 120. However, in some examples, the payment input system 102 may rely on the payment processing system 104 to extract the data from the payment requests.

Once the payment input system 102 has received the payment requests, the payment input system 102 may communicate the payment requests to the payment processing system 104, via the network 116.

The payment processing system 104 is shown to include a network interface circuit 122, an OCR circuit 124, an AI evaluation circuit 126, a payment request analysis circuit 128, a form generation circuit 130, a form analysis circuit 132, a payment correction circuit 134, and a payment processing circuit 136. In one arrangement, the payment processing system 104 is associated with an FI. Further, the payment processing system 104 may be maintained by an FI at which the payor maintains one or more accounts. The FI associated with the payment processing system 104 may be a bank; however, other FIs such as brokerage houses, credit card companies, international payment facilitators, or any other FI capable of processing payments from a payor to a payee are contemplated. In one arrangement, the payment processing system 104 may receive a payment request from the payment input system 102 via the network interface circuit 122. The network interface circuit 122 facilitates data communications to and from a network 116. The network interface circuit 122 may be configured to communicate wirelessly to the network 116, such as via Wi-Fi, Bluetooth, NFC, ZigBee, IR, RF, cellular (3G, 4G, LTE, CDMA), etc. In other arrangements, the network interface circuit 122 may communicate with the network 116 via a wired connection, such as via Ethernet, a LAN, a WAN, Firewire, USB, or other applicable wired interface. In some arrangements, data passing through the network interface circuit 122 is encrypted.

Similar to above, the OCR circuit 124 is configured to convert physical text, such as on a scanned document, or in a computer file containing non-machine readable text, such as a PDF files, or image file (JPEG, RAW, etc.). The OCR circuit 124 is configured to convert the physical text into computer-recognizable text, which can be used to extract data from the physical text, such as paper payment request 118 or digital payment request 120. In some examples, the payment input system 102 may provide the payment requests to the payment processing system 104 without performing an OCR on the payment request.

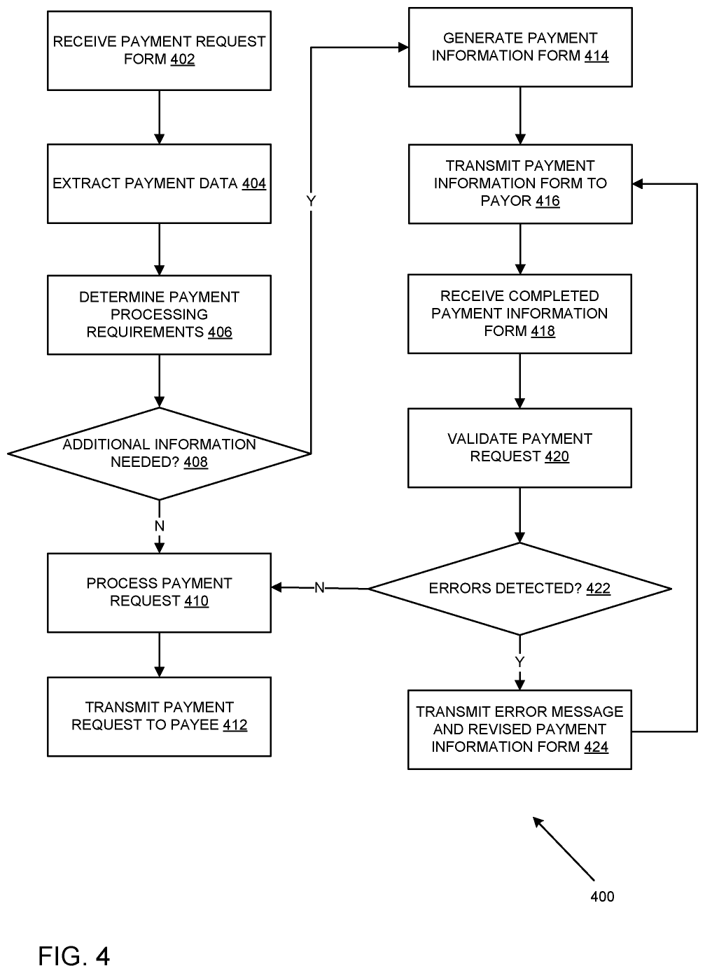

The AI evaluation circuit 126 is configured to review the data on the payment request, and extract data based on the content of the payment request. For example, the AI evaluation circuit 126 may be able to extract certain transactional information from the payment requests. Where the payment requests are paper payment requests 118, the AI evaluation circuit 126 can evaluate the form to extract the required information. Where the paper payment request 118 is an FI-provided form, the AI evaluation circuit 126 can extract data from the paper payment request 118 by evaluating the data provided by the payor and comparing the data against databases associated with the specific FI-provided form provided by the payor. In other examples, the paper payment request 118 may be a non-FI-provided form, such as a custom form generated by the payor and/or the payee. The AI evaluation circuit 126 can also extract data from the custom form by evaluating the computer-readable text provided by the OCR circuit 124. The AI evaluation circuit 126 can then use one or more AI algorithms, or other evaluation techniques, to extract the required information from the paper payment request 118, as described in further detail below with reference to FIG. 4. A similar technique can be used when evaluating a digital payment request 120. This allows a payor to present FI-provided or non-FI-provided payment request forms to the payment input system 102 for processing.

Information extracted by the AI evaluation circuit 126 may include payment amounts, account information, payee information, etc. In some examples the payment requests may be on non-standard forms or, in some cases, may simply be checks presented to the payment input system 102 for processing. The AI evaluation circuit 126 may evaluate all of the relevant data on the payment request to determine additional details about the requested payment. For example the AI evaluation circuit 126 may extract invoice numbers, payee account numbers, payee locations, etc. In some arrangements, the AI evaluation circuit 126 may access previous transactions performed by the payor to attempt to determine additional information related to the payment request. For example, where the payment request is directed to a certain payee account number only, the AI evaluation circuit 126 may access previous transactions with the provided payee account number to attempt to retrieve additional information about the payee, such as payee name, payee location/address, payee specific requirements, etc. In other arrangements, the AI evaluation circuit 126 may access one or more external databases to obtain additional information about the payee based on information provided in the payment request. For example, based on a name of the payee extracted from the payment request, the AI evaluation circuit 126 may access the databases to determine additional information about the payee, such as a location, organizational structures, associated FIs, etc. The AI evaluation circuit 126 may use one or more AI algorithms to process the data from the payment request. Example AI algorithms may include neural networks, genetic algorithms, reinforcement learning algorithms, evolutionary algorithms, swarm intelligence algorithms, or any other applicable AI algorithm.

The payment request analysis circuit 128 is configured to analyze the payment request as well as all data extracted from the payment request to determine if there is sufficient information available to process the payment. The payment request analysis circuit 128 may further be configured to review the extracted data to verify the accuracy of any information provided by the payor. In one arrangement, the payment request analysis circuit 128 evaluates the extracted data from the payment request to determine what, if any, additional information is required to process the payment. For example, where it is determined that the payee is located in a different country than the payor, the payment request analysis circuit 128 determines if additional information is required to complete a payment from the payor located in the payor's country and/or to a payee located in the payee's country. To illustrate, certain information may be required by the country that the payor is located in (e.g. the country that the money will be transferred from), the country that the payee is located in (e.g. the country that the money will be transferred to), the country that the payor is located in based on the payee country, and/or the country that the payee is located in based on the payor country. As an example, India requires that payments made to a payee in India include a payment purpose within the payment request. Other countries likewise have certain requirements for payment to a payee within said country.

Further, certain FIs associated with the payee or the payor may require additional information to process certain payments. For example, where the payment exceeds a certain monetary value, the payee FI may require additional information to verify the payment. Similarly, additional information may also be required by the payor FI. The payee may also require that certain information be provided when making a payment, such as an account number associated with the invoice, a project number, a payor ID number, or other applicable information. In one arrangement, the payment request analysis circuit 128 is configured to access one or more databases to determine information previously required by a payee FI. For example, where the payment processing system 104 is associated with an FI, the payment request analysis circuit 128 may evaluate previous transactions with the payee FI to determine what additional information has been requested in the past. In some arrangements, the payment request analysis circuit 128 receives payment information from the AI evaluation circuit 126 and/or the OCR circuit 124.

The payment request analysis circuit 128 determines what additional information is required to complete the transaction and is configured to transmit any required additional information to the form generation circuit 130. The form generation circuit 130 is configured to generate one or more forms that can be presented to the payor and which contain requests for the additional information required to complete the transaction. In one embodiment, the form generation circuit 130 generates a digital form that may be transmitted to the user via the user interface 108 of the payment input system 102. In other arrangements, the form generation circuit 130 may generate a digital form, which is transmitted directly to a payor, such as via an e-mail, a website pop-up message, a text message, an application associated with the payment processing system 104, or another digital delivery message. In some arrangements, the form generation circuit 130 may generate a physical form that can be manually filled in by the payor and submitted to the payment processing system 104 via the payment input system 102, or other form of input. In some examples, if it is determined that all the required information has been provided by the payor in the payment request form, the form generation circuit 130 will not generate any forms to present to the payor, and the payment request will be processed, as described in additional detail below.

The form analysis circuit 132 is configured to receive a previously generated form that has been completed by the payor. For example, the form analysis circuit 132 may receive the form via the network interface circuit 122. The form analysis circuit 132 is further configured to analyze the information provided in the received form and to determine if the required information has been provided, and is correct. If the form analysis circuit 132 determines that there are errors in the received form, or that the information provided is incorrect or insufficient, the payment correction circuit 134 can generate an alert which can be provided to the payor, instructing the payor to provide the additional information. In one embodiment, the payment correction circuit 134 is in communication with the form generation circuit 130. The payment correction circuit 134 may instruct the form generation circuit 130 to modify the previously generated form requesting additional information. The form generation circuit 130 may then modify the previously generated form to instruct the payor to provide the missing information or to correct the information previously provided and determined to be incorrect by the form analysis circuit 132. In some embodiments, the form analysis circuit may be combined into one or more of the OCR circuit 124 or the AI evaluation circuit 126.

The payment processing circuit 136 is configured to process the payment request once the payment processing system 104 determines that sufficient information has been provided to successfully process the payment. In one embodiment, the payment processing circuit 136 arranges for funds to be withdrawn from an account of the payor and transferred to an FI associated with the payee. For example, the payment processing circuit 136 may convert all of the received information into a data packet for transmitting to an FI associated with the payee. In one arrangement, the data packet includes all the information required for the payment receiving system 106 (e.g., a third-party payment processor) to process the payment (e.g. the data packet includes the information required for the payment receiving system to transfer the funds into an account associated with the payee to complete the payment.). For example, the payment processing circuit 136 may process the data from the payment request such that the data is configured as a Society for Worldwide Interbank Financial Telecommunications (SWIFT) message. A SWIFT message can be used to direct the transaction message to the payment receiving system 106 in a manner that the payment receiving system 106 will be able to understand. In other examples, the data may be configured as a Telex message, a Fedwire message, a Ripple message, a CHIPS message, an ACH message, or any other message used for communicating transactions between the payment processing system 104 and the payment receiving system 106. Processing the request may further include authorizing a transfer of funds from an account associated with the payor to an account associated with the payee. Additionally, processing the request may further include determining a path to the payment receiving system 106, via one or more intermediaries.

The payment receiving system 106, as described above, includes a recipient FI computing circuit 138. The recipient FI computing circuit 138 includes a network interface circuit 140 and a payment verification circuit 142. The network interface circuit 140 facilitates data communications to and from the network 116. The network interface circuit 140 may be configured to communicate wirelessly to the network 116, such as via Wi-Fi, Bluetooth, NFC, ZigBee, IR, RF, Cellular (3G, 4G, LTE, CDMA), etc. In other arrangements, the network interface circuit 140 may communicate with the network 116 via a wired connection, such as via Ethernet, a LAN, a WAN, Firewire, USB, or other applicable wired interface. In some arrangements, data passing through the network interface circuit 140 is encrypted. The payment verification circuit 142 is configured to process a payment received from the payment processing system 104. The payment verification circuit 142 can evaluate the received payment request and verify that the payment request is valid.

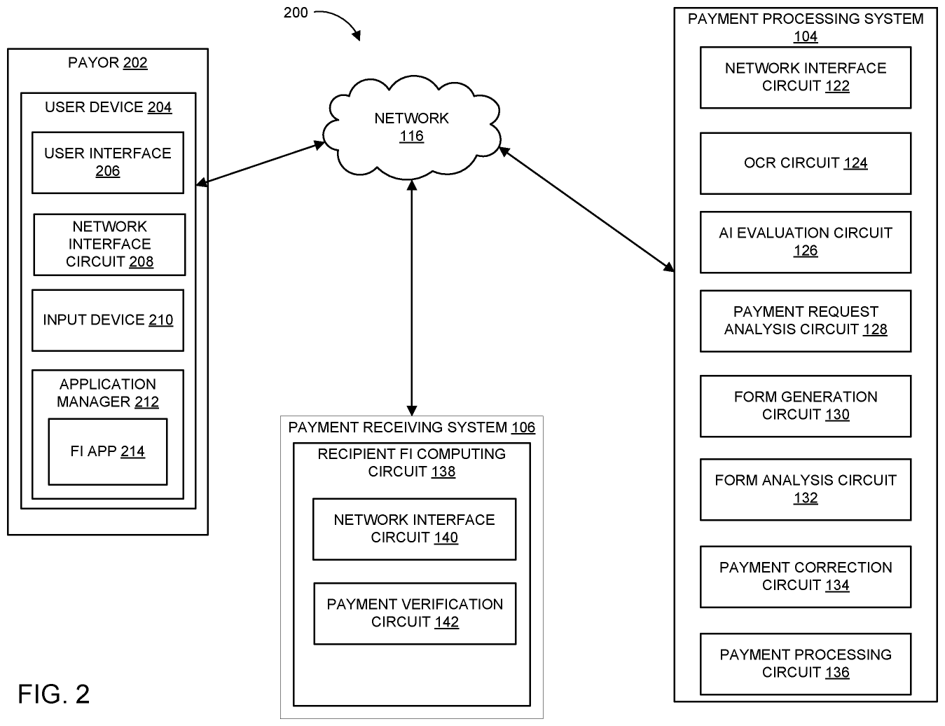

Turning now to FIG. 2, an alternative embodiment of the electronic payment processing system 100 is shown as electronic payment processing system 200. For clarity and brevity, the system 200 is discussed below in connection with the system described in FIG. 1. Specifically, the payment processing system 104, the payment receiving system 106, and the network 116 are understood to be the same as those described in regards to FIG. 1 above, except where otherwise noted. The system 200 includes a payor 202 and a user device 204 associated with the payor 202. The user device 204 may be any device associated with the payor 202 that can communicate with the network 116 and/or the payment processing system 104. In some arrangements, the user device 204 may include a user interface within an internet-accessible website. In other arrangements, the user device 204 may be a mobile device associated with the payor 202. Example mobile devices can include smartphones (e.g., iPhone®, Android® phones, Windows® phones, etc.), tablet computers (e.g., iPad®, Android® tablet, Microsoft Surface®, etc.), laptop computers, wearable device, or any other device capable of communicating with the network 116 and/or the payment processing system 104. In one embodiment, the user device 204 is used to provide access to the payment processing system 104. For example, the user device 204 may communicate with the payment processing system 104 via the network 116.

The user device 204 includes the user interface 206, a network interface circuit 208, an input device 210, and an application manager 212. The user interface 206 may be any interface providing inputs and outputs within the user device 204. For example, the user interface 206 may be a touchscreen display associated with a mobile device, such as a smartphone or tablet PC. In other examples, the user interface 206 may be a combination of a display and a separate input device, such as a keyboard. In still further examples, the user interface 206 may be an audio interface, such as a virtual assistant like Apple's® Siri® or other virtual assistants. The network interface circuit 208 facilitates data communications to and from the network 116. The network interface circuit 208 may be configured to communicate wirelessly to the network 116, such as via Wi-Fi, Bluetooth, NFC, ZigBee, IR, RF, cellular (3G, 4G, LTE, CDMA), etc. In other arrangements, the network interface circuit 208 may communicate with the network 116 via a wired connection, such as via Ethernet, a LAN, a WAN, Firewire, USB, or other applicable wired interface. In some arrangements, data passing through the network interface circuit 208 is encrypted.

The input device 210 may be similar to the input device 114 described in FIG. 1. For example, the input device 210 may be any device that allows the payor 202 to enter one or more payment requests into the user device 204. As described above, the payment requests may include various form types. For example, the payment requests may be paper forms or digital forms, as described above. In one example, the payment requests are forms that are provided and/or approved by an FI (e.g. forms provided by the FI to the payor.) Other examples of payment requests may include forms unique to the payor or the payee, but which contain similar information to the FI-provided payment request forms. As another example, the input device 210 may be a camera associated with the user device 204. Most modern personal devices such as smartphones, tablet computers, personal computers, and laptop computers include high resolution cameras that may be used to image one or more payment request documents. However, other input devices such as integrated scanning devices are also contemplated. In other arrangements, the input device 210 may be integral with the user interface 206. For example, the payor 202 may be able to input payment requests using the user interface 206 to enter information associated with the payment request. In other arrangements, the payor 202 can use the user interface 206 to input payment request data via an FI application 214, described below.

The application manager 212 is configured to manage one or more software applications (“apps”) associated with the user device 204. For example, the application manager 212 may manage the FI app 214. The FI app 214 may be a mobile banking application, associated with an FI used by the payor 202. In other arrangements, the FI app 214 may be a mobile application associated with the payment processing system 104. In one embodiment, the FI app 214 allows for direct communication between the user device 204 and the payment processing system 104. In one embodiment, the application manager 212 processes requests from the network interface circuit 208 to execute one or more applications. For example, the network interface circuit 208 may receive a request to open the FI app 214 to allow for the payment processing system 104 to interface with the user device 204. In one embodiment, the FI app 214 may be capable of activating the input device 210. For example, where the payor 202 indicates to the FI app 214 that the payor 202 wishes to create a payment request, the FI app 214 may activate the input device 210, such as a camera, to allow the payor 202 to capture the payment request. In other arrangements, the FI app 214 may act as the input device 210 by allowing the payor 202 to enter information related to the payment request via the user interface 206.

The FI app 214 may further be configured to receive forms generated by the form generation circuit 130. For example, the application manager 212 may receive a request from the payment processing system 104 to execute the FI app 214. The payment processing system 104 may then transmit an information request form generated by the form generation circuit 130 to the FI app 214 for display to the payor 202. Further, the FI app 214 may allow the payor 202 to enter the requested information into the generated form using the user interface 206 and/or the input device 210. Additionally, when additional information is requested, such as when the payment correction circuit 134 determines that more or corrected information is needed, the FI app 214 may display the request for additional information directly to the payor 202 and allow the requested data to be input via the user interface 206 and/or input device 210.

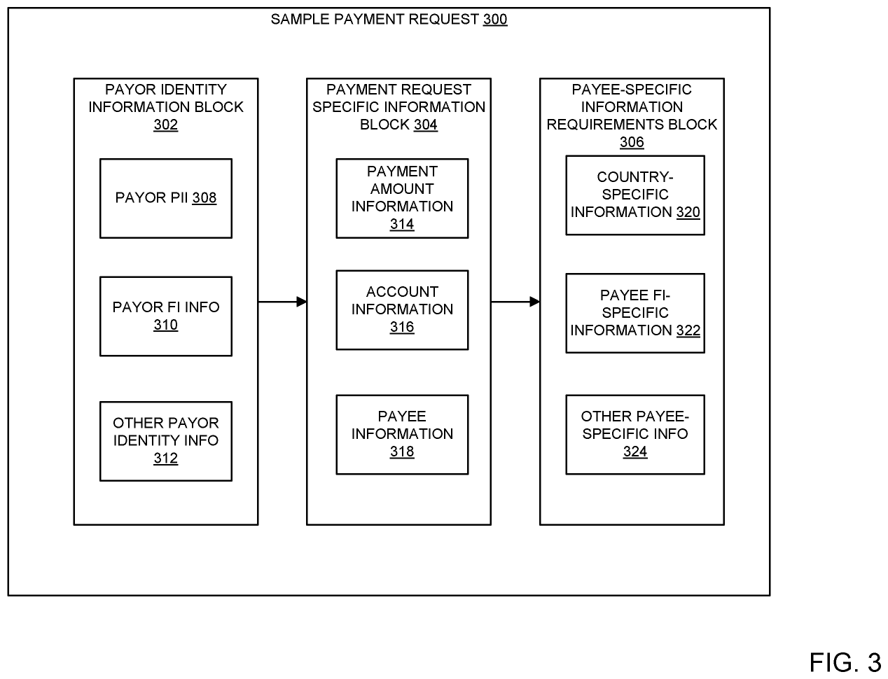

Turning now to FIG. 3, a block diagram illustrating an example payment request 300 is shown. For example, the payment request 300 may be a message that is transmitted from the payment processing system 104 (e.g., the originating bank) to the payment receiving system 106 (e.g., the third-party payment processing entity, the recipient bank, etc.). The payment request 300 includes data blocks, such as a payor identity information block 302, a payment request specific information block 304, and a payee-specific information requirements block 306. However, it is contemplated that other payment requests may include more or fewer data blocks, as required. The payor identity information block 302 may include payor personally identifiable information (PII) 308, payor FI information 310, and other payor identity information 312. However, it is contemplated that the payor identity information block 302 may include more information or less information, as needed. The various data blocks may be packaged in a single data file, which may be encrypted.

The payor PII 308 can include information about the payor that serves to identify the payor. This can includes PII such as a social security number, a driver's license number, a passport number, a photo ID, biometric data (fingerprints, eye scans, voice recordings), a phone number, or other PII that serves to identify the payor. The payor FI information 310 can include information relating to the FI associated with the payor, such as the FI name, address, tax ID number, phone number, FDIC number, bank identification number (BIN), routing number, or other information relating to the identity of the payor FI. The other payor identity information 312 may include any other information related to the payor that may be required to complete the payment request 300.

The payment request specific information block 304 may include one or more of payment amount information 314, account information 316, and payee information 318. The payment amount information 314 may include data related to a value associated with the payment request 300. For example, the value of money being transferred, the amount of credit requested or being used, the currency type used, etc. The account information 316 can include information relating to an account associated with the payor, such as account numbers, routing numbers, account balances, or other information related to the account of the payor to be used to process the payment request 300. Finally, the payee information 318 may include data related to the intended payee associated with the payment request 300. The payee information 318 may include the name of the payee, an account of the recipient, an FI associated with the payee, or other information related to the payee. In one embodiment, the payee information 318 includes information about a country associated with the payee, such as the country in which the payee resides. The payee information 220 may further include information related to the FI associated with the payee. For example, information such as the FI name, address, tax ID number, phone number, FDIC number, bank identification number (BIN), routing number, or other information relating to the identity of the payee FI may be included in the payee information 318.

The payee-specific information requirements block 306 may include information related specifically to the payee. Specifically, the payee-specific information requirements block 306 may include data that is required by the payee, or a government or entity associated with the payee, to process the requested transaction. For example, the payee-specific information requirements block 306 may include country-specific information 320, payee FI-specific information 322, and/or other payee-specific information 324. The country-specific information 320 may include information that is required for specific transaction in a given country. For example, if the request is a payment to a recipient in India, the payment request 300 requires a purpose of payment code. In other examples, other countries may impose specific requirements on the payment request 300, such as payment purposes, a detailed list of goods or services provided for the payment, the origin of the funds used in the payment, etc. The payee FI-specific information 322 may include information specifically required by the payee FI, such as additional PII associated with the payee, specific currencies to be used, etc. Finally, other payee-specific information 324 includes all other information required by the payee to complete the payment request 300. The other payee-specific information 324 may include information specifically requested by the payee, such as an associated purchase or transaction number, requested currency, etc.

FIG. 4 is a flow chart illustrating an electronic payment request method 400, according to some embodiments. In one arrangement, the electronic payment request method 400 is performed by the payment processing system 104, as described above and in further detail below. The electronic payment request method 400 extracts payment data from one or more payment requests to determine details regarding the requested payment. The electronic payment request method 400 further requests additional information, if required, from the payor requesting the payment. The electronic payment request method 400 then validates the payment request and all associated data and processes the payment request. For clarity and brevity, the method 400 is discussed below in connection with the systems described in FIGS. 1 and 2.

The payment processing system 104 receives one or more payment request forms at 402. In one embodiment, the payor enters the payment request forms using the payment input system 102, which may transmit the payment request forms to the payment processing system 104. However, in other arrangements, the payor enters the payment request forms using a user device associated with the payor, such as user device 204 described above. In such arrangements, the payment processing system 104 receives the payment request form(s) from the user device 204. The payment request forms may be various documents or other forms used by the payor to initiate a payment to a payee. For example, the payment request forms may be physical documents, such as checks, wire transfer requests, generated invoice payment documents, credit authorization forms, or other physical forms of payment requests. In some arrangements, the payment request documents are physical documents provided to an FI by the payor in a face-to-face transaction. For example, the payor may present a list of accounts and an amount that is to be paid to each of them on a physical document. The payment requests may further be electronic forms. For example, the payment request forms may be generated using one or more online tools with an FI associated with the payor. For example, digital checks, credit card transactions, payment services (PayPal®, Amazon Payments® Apple Pay®, etc.), mobile wallet applications, online fund transfer requests, online bill-pay, and other known digital payment methods. In other examples, the electronic forms may be digital versions of the physical forms described above, such as .pdf files, .jpeg files, .doc files, .xls files, or other available digital document file types. In one arrangement, where the payment request forms are physical documents, the payment request forms are converted into electronic documents by the payment input system 102 and/or the user device 204.

The payment processing system 104 extracts payment data from the payment request form at 404. In one arrangement, extracting payment data includes converting the payment request form into a format that is machine-readable. For example, where the payment request forms are physical forms, the OCR circuit 124 may be used to convert the physical documents into computer-readable text. In some examples, the OCR circuit 112 of the payment input system 102 converts the physical documents to computer-readable text. Further, the OCR circuits 112, 124 may also be used to convert electronic payment request forms into computer-readable data. For example, where the user provides the payment request forms in .pdf, jpeg, or other non-text-based files, the OCR circuits 112, 124 may evaluate the payment request forms and convert the text into machine-readable data.

In further arrangements, the payment processing system 104 may extract payment data using the AI evaluation circuit 126. As described above, the AI evaluation circuit 126 may be used to extract payment data from the payment request forms. In one embodiment, the OCR circuits 112, 124 provide machine-readable data for the AI evaluation circuit 126 to analyze. For example, the AI evaluation circuit 126 may analyze the data within the payment request forms to determine key payment request data, such as payor identity information, payee information, amount information, etc. In some arrangements, the AI evaluation circuit 126 may use the extracted data to determine one or more aspects about the payment request. For example, in some examples the payment requests may be non-standard forms (e.g. a payment request generated by a system of the payor) or, in some cases, may simply be checks presented to the payment input system 102 for processing. The AI evaluation circuit 126 may evaluate all of the relevant data of the payment request to extract additional details about the requested payment, such as invoice numbers, payee account numbers, payee locations, etc.

In some arrangements, the AI evaluation circuit 126 may access previous transactions performed by the payor to attempt to determine additional information related to the payment request. For example, where the payment request is directed to a certain payee account number only, the AI evaluation circuit 126 may access previous transactions with the provided payee account number to attempt to retrieve additional information about the payee, such as the payee name, payee location/address, payee-specific requirements, etc. In other arrangements, the AI evaluation circuit 126 may access one or more external databases to obtain additional information about the payee based on information provided in the payment request. For example, based on a name of the payee extracted from the payment request, the AI evaluation circuit 126 may access the databases to determine additional information about the payee, such as a location, organizational structures, associated FIs, etc. Further, the AI evaluation circuit 126 may be able to determine other additional data such as account information. For example, the AI evaluation circuit 126 may infer which account the payor would like to fund the payment from based on historical knowledge, such as via the one or more external databases described above. As another example, the AI evaluation circuit 126 may determine that the payor always pays the payee via a certain account and can infer that this is the account that the payor wishes to use. In addition to the above examples, the AI evaluation circuit 126 may further be configured to determine additional data regarding the payment request, as needed. The AI evaluation circuit 126 may further be configured to add the determined additional information (i.e. payee information, payment request-specific information, etc.) to the payment request for further processing. In some arrangements, the AI evaluation circuit 126 may inform the payor of any inferences that the AI evaluation circuit 126 is making to confirm the inferences are correct. For example, the AI evaluation circuit 126 may communicate with the payor via the payment input system 102 and/or the user device 204. In some arrangements, the payor may then be able to confirm the additional information provided by the AI evaluation circuit 126 or refuse the changes.

The payment data is extracted as described above, and then payment processing requirements are determined at 406. In one embodiment, the payment processing requirements are determined by the payment request analysis circuit 128, as described above. In one arrangement, the payment request analysis circuit 128 evaluates all the data provided by both the payment request form, as well as any additional payment data extracted, such as by the AI evaluation circuit 126. The payment request analysis circuit 128 may evaluate the payment data and determine the requirements based on multiple factors. Example factors include the countries of the payor and the payee, the amounts, the currency types, payee requirements, payee FI requirements, or other factors. Based on the evaluated factors, the payment request analysis circuit 128 determines what information is required to process the payment request. For example, where the payor is in the United States, and the payee is in India, the payment request analysis circuit 128 may determine what specific information is required to complete the transactions. These requirements may be different where the payor is in the United States and the payee is in Canada, and so forth. The payment request analysis circuit 128 may analyze all available data extracted at 406 to determine what requirements are needed to process the payment request.

Once the payment processing requirements are determined, the method 400 determines if additional information is needed to complete the transaction at 408. For example, where the payment request analysis circuit 128 determines that certain information is required but was not extracted from the payment request, the payment request analysis circuit 128 can determine that additional information is required to complete the transaction. Additional data may include payor identity information, payment request-specific information and/or payee-specific information requirements, as described above in FIG. 3. If additional information is not needed to complete the transaction, the payment request is processed at 410 and transmitted to the payment receiving system (i.e. the payor) at 412. In one arrangement, processing the payment includes organizing (i.e., compiling) the data from the transaction request into a data packet recognizable and readable by the payment receiving system 106. For example, the payment processing system 104 may process the data from the payment request such that the data is configured as a SWIFT message. A SWIFT message can be used to direct the payment request to the payment receiving system 106 in a manner that the payment receiving system 106 will be able to understand. In other examples, the data may be configured as a Telex message, a Fedwire message, a Ripple message, a CHIPS message, or any other message used for communicating transactions between the payment processing system 104 and the payment receiving system 106. Processing the request may further include authorizing a transfer of funds from an account associated with a payor to the payment receiving system 106. Additionally, processing the request may further include determining a path to the payment receiving system 106 via one or more intermediaries.

In some arrangements, one or more intermediaries may be between the payment processing system 104 and the payment receiving system 106, particularly where the payment processing system 104 and the payment receiving system 106 are in different countries and do not have an existing business relationship. The intermediaries may be institutions that have a business relationship with both the payment processing system 104 and the payment receiving system 106 and that can facilitate the completion of the requested transaction between the two. The intermediaries may be FIs, brokerage houses, third party transaction facilitators, governmental agencies, or other institutions that are capable of facilitating transactions between the payment processing system 104 and the payment receiving system 106. In some examples, multiple intermediaries may be required to get a transaction from the payment processing system 104 to the payment receiving system 106, and vice-versa. In some instances, the intermediaries may also have specific information requests that the payment processing system 104 will need to provide. The payment processing system 104 may be aware of the information required to complete the transaction using intermediaries and may require the payment processing system 104 to provide additional information if needed, as described below.

Where it is determined that additional information is required at 408, a payment information form is generated at 414. The payment information form may be generated by the form generation circuit 130. In one arrangement the form analysis circuit 132 may generate a payment information form that requests the additional information that is required to complete the payment request. The payment information form requests additional payment information from the payor. The payment information form is then transmitted to the payor at 416. In one arrangement, the payment information form may be an electronic form that is writeable such that the payor can input the requested information directly into the form. In one arrangement, the payment information form may be presented to the payor via the user interface 108 of the payment input system 102. In other arrangements, the payment information form may be presented to the payor via the user interface 206 of the user device 204. In still further arrangements, the payment information form may be a physical form that can be printed out and provided to the payor to provide the additional information. For example, where the payment processing system 104 is associated with a bank, the payor may interface with a teller to provide the payment requests. The form generation circuit 130 may output an electronic form that the teller can print out to have the payor complete the payment information form immediately.

The completed payment information form is received by the payment processing system 104 at 418. In some arrangements, the completed payment information form may be transmitted to the payment processing system 104 via the payment input system 102 and/or the user device 204. The payment request is then validated at 420. In one arrangement, the payment request is validated based on the originally-extracted payment data as well as the information provided via the payment information form. In one arrangement, the payment request analysis circuit 128 validates the payment request. Alternatively, in other arrangements, the form analysis circuit 132 validates the payment request. In further examples, the form analysis circuit 132 may extract the information from the payment information form and provide that data to the payment request analysis circuit 128 for final validation. The payment request may be determined to be valid where all the requirements determined at 410 are satisfied.

The payment request is also evaluated to determine if there are any errors at 422. Errors may occur where the payor has not provided all of the information requested in the payment information form. In other examples, errors may occur where the payor has provided incomplete or incorrect information via the payment information form. For example, if the payor is requested to enter an account number of the payee, an error may be detected where the account number is not a properly formatted account number (e.g. too many digits, too few digits, etc.). In some arrangements, the form analysis circuit 132 analyzes the payment information form to determine if there are any errors. If no errors are detected, the payment request is processed at 410, as described above. If errors are detected, an error message is transmitted to the payor along with a revised payment information form. In one arrangement, the error message and the revised payment information form are generated by the payment correction circuit 134; however, other circuits within the payment processing system 104 may also generate the error message and/or the revised payment information form. The revised payment information form may indicate what errors were in the previously presented payment information form, to allow the user to correct any determined errors. Similar to the payment information form described above, the revised payment information form may be presented to the payor via the user interface 108 of the payment input system 102 or via the user device 204. The payor then inputs the information into the revised payment information form at 416 to repeat the process described above.

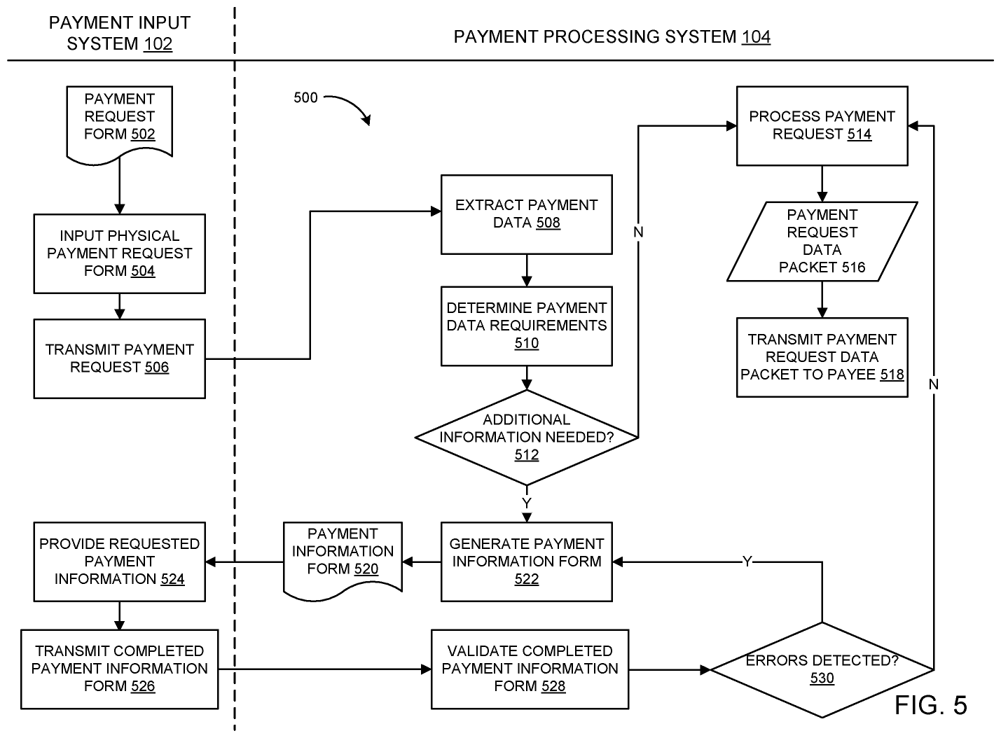

Turning now to FIG. 5, a flow diagram illustrating an example implementation 500 of the method 400 shown in FIG. 4 is described. For clarity and brevity, the implementation 500 is discussed below in connection with the system described in FIG. 1. In one arrangement, the implementation 500 is performed by the payment processing system 104, as described above and in further detail below. The payment processing system 104 extracts payment data from a physical payment request form and determines what payment data is required to process the request. If additional information is required, the payment processing system 104 generates a payment information form which is transmitted to the payor. The completed payment information form is then validated by the payment processing system 104 and the payment request is processed.

A physical payment request form 502 is input into the payment input system 102 at 504. In one embodiment, the payor inputs the physical payment request form 502 using the payment input system 102. In one arrangement, the payment input system is an ATM. For example, the ATM may include an optical imaging device (i.e. input device 114) for imaging the payment request from 502. The payment request forms may be various documents or other forms used by the payor to initiate a payment to a payee. For example, the payment request forms may be documents such as checks, wire transfer requests, generated invoice payment documents, credit authorization forms, or other physical forms of payment requests. In one arrangement, the payment input system 102 converts the physical payment request form 502 into an electronic payment request. The physical payment request form 502 is then transmitted to the payment processing system 104 at 506. Payment data is extracted from the payment request at 508. The payment processing system 104 may use the AI evaluation circuit 126 to extract payment data from the payment request as described above. For example, the AI evaluation circuit 126 may be configured to analyze the data within the payment request forms to determine key payment request data, such as payor identity information, payee information, amount information, etc. In some embodiment, the AI evaluation circuit 126 may extract data to determine one or more aspects about the payment request, such as invoice numbers, payee account numbers, payee locations, etc. In other examples, the OCR circuit 124 may be used to extract payment data from payment request.

Based on the extracted payment data, the payment processing system 104 determines payment data requirements (e.g. the data required to process the payment) associated with the payment request at 510. In one arrangement, the payment request analysis circuit 128 evaluates all the data extracted from the payment request to determine what information is required to complete the payment. The payment request analysis circuit 128 may evaluate the payment data and determine what information is required based on multiple factors, such as the countries of both the payor and the payee, the amount of the payment, the currency used, payee specific-requirements, payee FI-specific requirements, or any other relevant factor.

The payment request is then analyzed to determine if additional information is required at 512, based on the requirements determined by the payment request analysis circuit 128. If no additional information is required the payment request is processed at 514. During processing, the payment request is converted into a payment request data packet 516. The payment request data packet 516 is configured to be recognizable and readable by an FI associated with the payee (i.e. payment receiving system 106). In embodiment, the payment request data packet 516 is configured as a SWIFT message. In other examples, the payment request data packet 516 may be configured as a Telex message, a Fedwire message, a Ripple message, a CHIPS message, or any other messaging format used form communicating financial data between institutions. Once the payment request data packet 516 is generated, it is transmitted to the payee at 518.

If additional information is determined to be needed, a payment information form 520 is generated at 522. In one arrangement, the payment information form 520 is generated by the form generation circuit 130. The payment information form 520 requests additional information from the payor required to complete the payment request. For example, the payment information form 520 may be an electronic form that is writeable such that the payor can provide the requested payment information at 524. In one arrangement, the payment information form 520 may be presented to the payor via the user interface 108 of the payment input system 102. For example, a user interface of an ATM may instruct the payor as to what information is required to complete the payment request. The payor may then use the user interface 108 of the ATM to provide the required information. In other arrangements, the payment information form 520 may be presented to the payor via the user interface 206 of the user device 204. In still further arrangements, the payment information form may be a physical form that can be printed out and provided to the payor to provide the additional information. For example, where the payment processing system 104 is associated with a bank, the payor may interface with a teller to provide the payment requests. The form generation circuit 130 may output an electronic form that the teller can print out and have the payor complete the payment information form 520 immediately. In other arrangements, an ATM or ABM may be configured to output a paper payment information form 520 that the payor can use to provide the additional requested information. For example, the payor may provide the required information in the payment information form 520, and input the payment information form 520 containing the required data into the ATM using the input device 114.

Once the payor provides the request payment information listed on the payment information form 520, the completed payment information form is transmitted to the payment processing system 104 at 526. The payment processing system 104 validates the completed payment information form at 528. In one arrangement, the payment processing system 104 validates the completed payment information form by determining that all the requested information has been provided. The payment processing system 104 may further analyze the received payment information form to determine if the information provided is accurate. During the validation process, errors in the payment information form may be detected at 530. If no errors are detected, the payment request is processed at 514. If errors are detected, the payment processing system 104 generates a new payment information form. In some arrangements, the new payment information form may be a revised version of the previously generated payment information form. The new payment information form is configured to indicate the errors to the payor. The payor can then input the required or corrected information at 524, as described above, and the process can be repeated until the payment information form is validated with no errors.

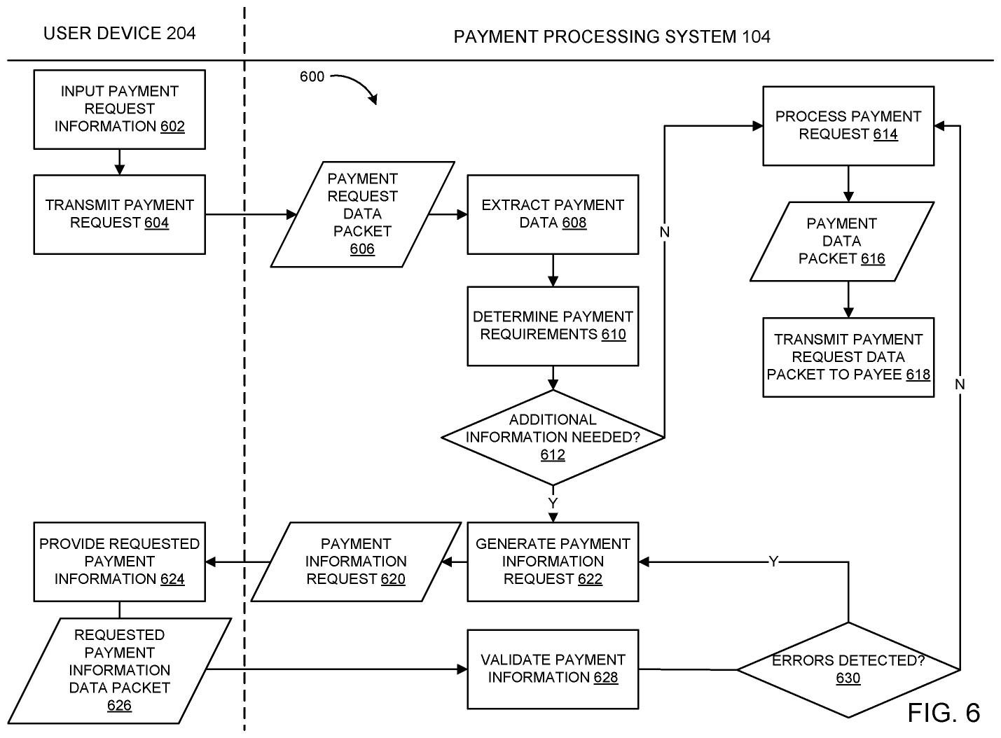

Turning now to FIG. 6, a flow diagram illustrating an example implementation 600 of the method shown in FIG. 4 is described. For clarity and brevity, the implementation 600 is discussed below in connection with the system described in FIG. 2. In one arrangement, the implementation 600 is performed by the payment processing system 104, as described above and in further detail below. The payment processing system 104 extracts payment data from a payment request data packed transmitted from the user device 204, and determines what payment data is required to process the request. If additional information is required, the payment processing system 104 generates a payment information form which is transmitted to the payor. The completed payment information form is then validated by the payment processing system 104 and the payment request is processed.

In one embodiment, the payor inputs the payment request via the user device 204. In one arrangement, the payor may input the payment request using the user interface 206. For example, the payor may access a website or other internet-based portal associated with the payment processing system 104, and directly provide the payment request. In other examples, the payor may utilize a mobile banking application, such as FI app 214 to provide the payment request. The FI app 214 may generate an interface on the user interface 206 that allows the payor to input the payment information. In other arrangements, the payment request forms may be physical documents or other forms used by the payor to initiate a payment to a payee. For example, the payment request forms may be documents such as checks, wire transfer requests, generated invoice payment documents, credit authorization forms, or other physical forms of payment requests. In one arrangement, the payor may convert the physical payment request into an electronic payment request. For example, the payor may use the input device 210 to image the physical payment request form to convert the physical payment request form into an electronic payment request form.

The payment request is then transmitted to the payment processing system 104 at 606. In one arrangement, the payment request is transmitted to the payment processing system 104 as a payment request data packet 606. Payment data is extracted from the payment request data packet 606 at 608. The payment processing system 104 may use the AI evaluation circuit 126 to extract payment data from the payment request data packet 606 as described above. For example, the AI evaluation circuit 126 may be configured to analyze the data within the payment request forms to determine key payment request data, such as payor identity information, payee information, amount information, etc. In some arrangements, the AI evaluation circuit 126 may extract data to determine one or more aspects about the payment request, such as invoice numbers, payee account numbers, payee locations, etc. In other examples, the OCR circuit 124 may be used to extract payment data from the payment request data packet 606 where the payment request data packet 606 includes data that is not computer readable text.

Based on the extracted payment data, the payment processing system 104 determines payment data requirements (e.g. the data required to process the payment) associated with the payment request at 610. In one arrangement, the payment request analysis circuit 128 evaluates all the data that was extracted from the payment request data packet 606 to determine what information is required to complete the payment. The payment request analysis circuit 128 may evaluate the extracted payment data and determine what information is required based on multiple factors, such as the countries of both the payor and the payee, the amount of the payment, the currency used, payee specific requirements, payee FI specific requirements, or any other relevant factor.

The payment request is then analyzed to determine if additional information is required at 612, based on the requirements determined by the payment request analysis circuit 128. If no additional information is required the payment request is processed at 614. During processing, the payment request is converted into a payment data packet 616. The payment data packet 616 is configured to be recognizable and readable by an FI associated with the payee (i.e. payment receiving system 106). In arrangement, the payment data packet 616 is configured as a SWIFT message. In other examples, the payment data packet 616 may be configured as a Telex message, a Fedwire message, a Ripple message, a CHIPS message, or any other messaging format used form communicating financial data between institutions. Once the payment data packet 616 is generated, the payment data packet 616 is transmitted to the payee at 618.

If additional information is determined to be needed, a payment information request 620 is generated at 622. In one arrangement, the payment information request 620 is generated by the form generation circuit 130. The payment information request 620 includes a request for additional information from the payor required to complete the payment request. For example, the payment information request 620 may be an electronic form that is writeable such that the payor can provide the requested payment information at 624. In one arrangement, the payment information request 620 may be presented to the payor via the user interface 206 of the user device 204. For example, the payment processing system 104 may communicate with the application manager 212 to execute the FI app 214. The payment information request 620 is then displayed to the payor via the user interface 206. The FI app 214 may further allow the payor to provide the requested payment information directly. In other example, the payment information request may be generated on a web portal (e.g. a website) that the payor can access via the user device 204 and through which the payor can provide the requested information.

Once the payor provides the request payment information listed on the payment information request 620, the completed payment information request 620 is transmitted to the payment processing system 104 at 626. The payment processing system 104 validates the received payment information at 628. In one arrangement, the payment processing system 104 validates the received payment information by determining that all the requested information has been provided. The payment processing system 104 may further analyze received payment information to determine if the information provided is accurate. During the validation process, errors in the received payment information may be detected at 630. If no errors are detected, the payment request is processed at 614. If errors are detected, the payment processing system 104 generates a new payment information request. In some arrangements, the new payment information request may be a revised version of the previously generated payment information request 620. The new payment information request is configured to indicate the errors to the payor. The payor can then input the required or corrected information at 624, as described above, and the process can be repeated until the payment information is validated with no errors.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more dedicated processors communicatively coupled to one or more dedicated memory or memory devices. In this regard, the one or more dedicated processors may execute instructions stored in the dedicated memory or may execute instructions otherwise accessible to the one or more dedicated processors. In some embodiments, the one or more dedicated processors may be embodied in various ways. The one or more dedicated processors may be constructed in a manner sufficient to perform at least the operations described herein. In some embodiments, the one or more dedicated processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more dedicated processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more dedicated processors may take the form of a single core processor, multi-core processor (e.g., a dual core processor, triple core processor, quad core processor, etc.), microprocessor, etc.

Any foregoing references to currency or funds are intended to include fiat currencies, non-fiat currencies (e.g. precious metals), and math-based currencies (often referred to as cryptocurrencies). Examples of math-based currencies include Bitcoin, Litecoin, Dogecoin, and the like. It should be noted that although the diagrams herein may show a specific order and composition of method steps, it is understood that the order of these steps may differ from what is depicted. For example, two or more steps may be performed concurrently or with partial concurrence. Also, some method stops that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A computer-implemented method comprising:
receiving, by a financial institution computing system, a payment request from a payor, wherein the payment request is a request for a transaction between the payor and a payee;
extracting, by the computing system, payment data from the payment request, the payment data comprising payee identification data and payment amount data;
determining, by the computing system, additional payment information required to process the payment request, comprising:
comparing, by an artificial intelligence (AI) circuit, the payment request against databases associated with the payment request and external databases, comprising obtaining payee-specific information comprising at least one of an associated payee financial institution and a payee location;
retrieving, by the artificial intelligence (AI) circuit, a payment data set comprising at least one prior completed payment request between the payor and the payee; and
based on the prior completed payment request, determining a payor account and payee-specific information required in a prior completed payment request;
generating, by the computing system, a payment information request form, the payment information request form including one or more requests for specific data from the payor based on the determined additional payment information, wherein the payment information request form comprises at least one of a payor identity information request or payee-specific information requirements request;
transmitting, by the computing system, the payment information request form to a computing device of the payor, responsive to the determination of the additional payment information required to process the payment request;
responsive to receiving a confirmation from the computing device of the payor, validating, by the computing system, the payment request based on the payment data and the determined additional payment information; and
generating, by the computing system, a payment request data packet comprising the determined additional payment information.

2. The method of claim 1, further comprising:
transmitting, from the computing system, the payment information request form to the payor; and
receiving, at the computing system, a completed payment information request form from the payor.

3. The method of claim 1, further comprising:
in response to determining that the payment request is invalid, generating, by the computing system, an additional payment information request form;
transmitting, from the computing system, the additional payment information request form to the payor;
receiving, at the computing system, a completed additional payment information request form from the payor; and
validating, by the computing system, the payment request based on the payment data and the completed additional payment information request form.

4. The method of claim 1, further comprising transmitting the payment request data packet from the computing system to a financial institution associated with the payee.

5. The method of claim 1, wherein extracting the payment data from the payment request comprises converting a paper form to an electronic form and evaluating data in the electronic form to extract the payment data.

6. (canceled)

7. The method of claim 1, wherein the payment information request form further comprises a payment request-specific information request.

8. The method of claim 1, wherein the payee-specific information requirements request includes payee country-specific information.

9. The method of claim 1, wherein the payment request data packet is a Society for Worldwide Interbank Financial Telecommunications (SWIFT) compatible data packet.

10. A financial institution computing system comprising:
a payment processing system, the payment processing system configured to:
receive, via a network interface circuit, a payment request from a payor, wherein the payment request is a request for a transaction between the payor and a payee;
extract payment data from the payment request using an optical character recognition circuit, the payment data comprising payee identification data and payment amount data;
determine additional payment information required to process the payment request, comprising:
comparing, by an artificial intelligence (AI) circuit, the payment request against databases associated with the payment request and external databases, comprising obtaining payee-specific information comprising at least one of an associated payee financial institution and a payee location;
retrieving, by the artificial intelligence (AI) circuit, a payment data set comprising at least one prior completed payment request between the payor and the payee; and
based on the prior completed payment request, determining a payor account and payee;
generate a payment information request form, the payment information request form including one or more requests for specific data from the payor based on the determined additional payment information, wherein the payment information request form comprises at least one of a payor identity information request or a payee-specific information requirements request;
transmit the payment information request form to a computing device of the payor;
responsive to receiving a confirmation from the computing device of the payor, validate the payment request based on the payment data and the determined additional payment information;
generate a payment request data packet comprising the determined additional payment information; and
transmit the payment request data packet, via the network interface circuit, to a financial institution associated with the payee.

11. The system of claim 10, wherein the payment processing system is further configured to:
transmit the payment information request form to the payor; and
receive a completed payment information request form from the payor.

12. The system of claim 10, wherein the payment processing system is further configured to:
in response to determining the payment request is invalid, generate an additional payment information request form;
transmit the additional payment information request form to the payor;
receive a completed additional payment information request form from the payor; and
validate the payment request based on the payment data and the completed additional payment information request form.

13. The system of claim 10, wherein the payment request is a paper form.

14. The system of claim 13, wherein extracting the payment data from the payment request comprises converting the paper form to an electronic form, and evaluating data in the electronic form to extract the payment data.

15. (canceled)

16. The system of claim 10, wherein the payment information request form further comprises a payment request-specific information request.

17. The system of claim 10, wherein the payee-specific information requirements request includes payee country-specific information.

18. A system for processing electronic payments, the system comprising:
a payment processing system, the payment processing system configured to:
receive a payment request from a payor at a network interface circuit, wherein the payment request is a request for a transaction between the payor and a payee;
extract payment data from the payment request using an optical character recognition circuit, the payment data comprising payee identification data and payment amount data;
determine additional payment information required to complete the payment request, comprising:
comparing, by an artificial intelligence (AI) circuit, the payment request against databases associated with the payment request and external databases, comprising obtaining payee-specific information comprising at least one of an associated payee financial institution and a payee location;
retrieving, by the artificial intelligence (AI) circuit, a payment data set comprising at least one prior completed payment request between the payor and the payee; and
based on the prior completed payment request, determining a payor account;
generate a payment information request form, the payment information request form including one or more requests for specific data from the payor based on the determined additional payment information, and wherein the payment information request form further comprises at least one of a payor identity information request or a payee-specific information requirements request;
transmit the payment information request form to a computing device of the payor;
responsive to receiving a response from the computing device of the payor, validate the payment request based on the payment data and the determined additional payment information;
in response to determining the payment request is invalid, generate an additional payment information request form and transmit the additional payment information request form to the computing device of the payor;
receive a completed additional payment information request form via the network interface circuit, the completed additional payment information request form comprising a second set of additional payment information;
revalidate the payment request based on the payment data and the second set of additional payment information in the received completed additional payment information request form to re-determine if the payment request is valid;
in response to determining that the payment request is valid at the revalidation, generate a payment request data packet, the payment request data packet comprising the determined additional payment information and the second set of additional payment information; and
transmit the payment request data packet, via the network interface circuit, to a financial institution associated with the payee.

19. The system of claim 18, wherein the payment request is a paper form.

20. The system of claim 19, wherein extracting the payment data from the payment request comprises converting the paper form to an electronic form, and evaluating data in the electronic form to extract the payment data.

21. (canceled)
